(19) United States
(12) Patent Application Publication
(10) Pub. No.: US 2010/0242372 A1
(43) Pub. Date: Sep. 30, 2010

(54) Foldable Garage Door Trim Systems

(75) Inventor: John Schram, Archbold, OH (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: NAPOLEON SPRING WORKS, INC.

(21) Appl. No.: 12/732,337

(22) Filed: Mar. 26, 2010

Related U.S. Application Data
(60) Provisional application No. 61/164,059, filed on Mar. 27, 2009.

(51) Int. Cl. E06B 7/22

(52) U.S. Cl. 49/479.1

(57) ABSTRACT

A door trim including a board having a front surface, a rear surface and an optional edge seal wherein the board includes at least one hinge separating a first board section from an adjacent second board section.

This application claims priority to U.S. provisional patent application No. 61/164,059 filed on Mar. 27, 2009, the specification of which is incorporated herein in its entirety.

### (1) FIELD OF THE INVENTION

The present invention relates generally to door trims, and more particularly to door trims that include one or more hinges that allow the trim to be folded during storage and transport.

### (2) BACKGROUND OF THE INVENTION

Garage door trim that is installed around the perimeter of and at the bottom of garage doors is well known. The trim is installed in a manner to operate in unison with overhead garage doors to seal the perimeter of a garage door opening when the garage door is closed. Generally, the perimeters and bottoms of garage door openings span distances of 10 to 20 feet or more. Current garage door trims that span these distances are generally single pieces of trim having a similar length of 10 to 20 feet or more. As a result, current garage door trim is difficult to store, box, ship and to install because of its length.

Manufacturing door trim systems in short lengths that are installed edge to edge to span large distances is one possible solution to the problems created by long single piece door trims. However, using short lengths creates new problems with aligning and uniting a multitude of trim pieces to form an installed door trim. There is a need, therefore, for door trim systems that overcome one or more of the problems recited above.

### SUMMARY OF THE INVENTION

The present invention includes a door trim with at least one hinge that allows the door trim to be folded during storage and transport and then unfolded for installation around the perimeter frame or at the bottom of a garage door opening.

One aspect of the present invention is a door trim system including a board having a front surface, a rear surface, a first face and a second face that is a flexible weather seal, the board including at least one hinge separating a first board section from a second board section.

Another aspect of the invention is a door trim system which provides an unbroken trim for aesthetic value.

Another aspect of the invention is a door trim system which provides ease in installation and creates a better seal between the board sections.

Further aspects of the invention will be brought out in the following part of the specification, wherein detailed description is for the purpose of fully disclosing the invention without placing limitations thereon.

### BRIEF DESCRIPTION OF THE DRAWINGS

FIGS. 1A-1C are perspective views of a foldable perimeter door trim embodiment of the invention demonstrating the process of folding the door trim;

FIGS. 2A-2H are various views of a foldable door trim embodiments of this invention including a cross-sectional view (FIG. 2A), partial plan views (FIGS. 2B-2D), and partial schematic medial cross-sectional views (FIGS. 2E-2H);

FIGS. 3A-3C are perspective views of a foldable door trim embodiment of this invention demonstrating the process of unfolding the door trim;

FIGS. 4A-4C are perspective views of a foldable door trim embodiment of this invention demonstrating the process of unfolding the door trim;

FIG. 5A-5D include cross-sectional view (FIG. 5A) and perspective views (FIGS. 5B-5D) of a foldable door trim embodiment of this invention illustrating the lamination or co-extrusion of the door trim system and demonstrating the process of unfolding the door trim system; and

FIG. 6A-6B are side perspective views of a hinged door trim embodiment of this invention.

### DETAILED DESCRIPTION OF THE INVENTION

The present invention is directed to foldable door trims including one or more hinges that allow equivalent or non-equivalent length sections of the door trim to be folded against one another. The door trims of this invention were developed primarily to trim garage door openings and the embodiments are discussed in the context of their use as garage door trim. However, the door trim of this invention is useful for timing all types of openings. Several embodiments of door trims of this invention are described in more detail with reference to the application figures below.

Referring now to Figures, there are shown a variety of foldable door trim embodiments of the present invention and generically identified with numeral 20. Door trim 20 includes a board 1 an optional weather seal 2 and an optional edge seal 6. Board 1 further includes a front surface 4 that is outwardly facing when installed and rear surface 3 that abuts a garage door perimeter or garage door bottom when installed. Rear surface 3 may optionally be partially or completely covered by weather seal 2. Board 1 is the central portion of the trim of this invention. Board 1 may be made of any material that gives the trim the desired amount of rigidity. For example, board 1 may be made of wood, plastic, a polymeric material or any mixture and combinations thereof. Board 1 will generally be made from an extruded polymeric material. Moreover, while board 1 lends rigidity to the trim, it is not required that the board 1 be unbendable.

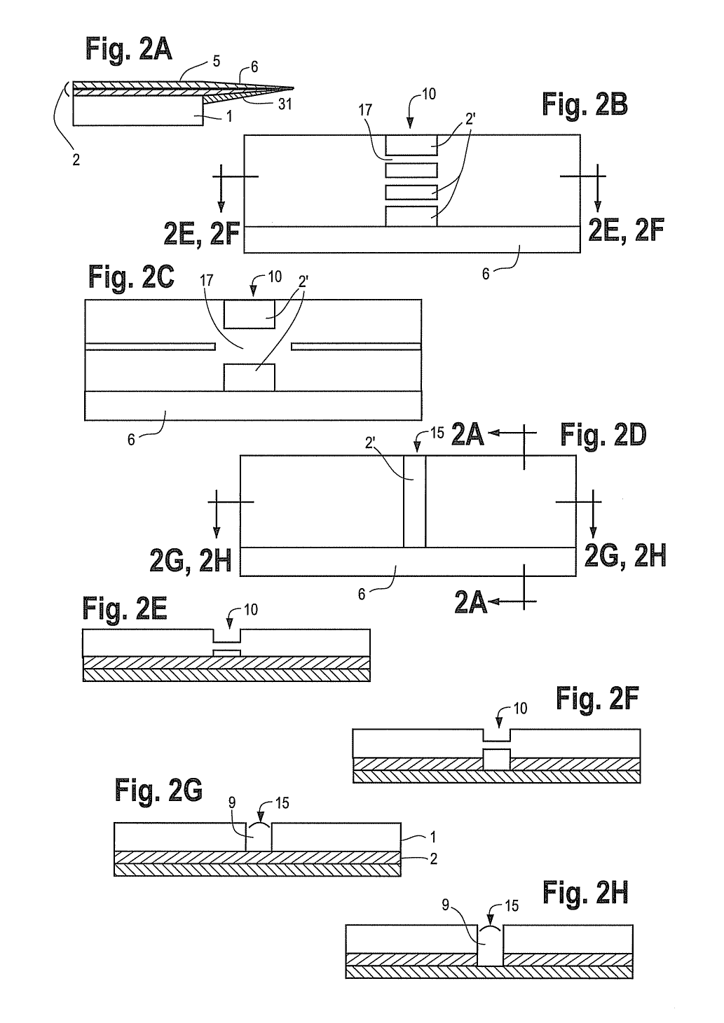

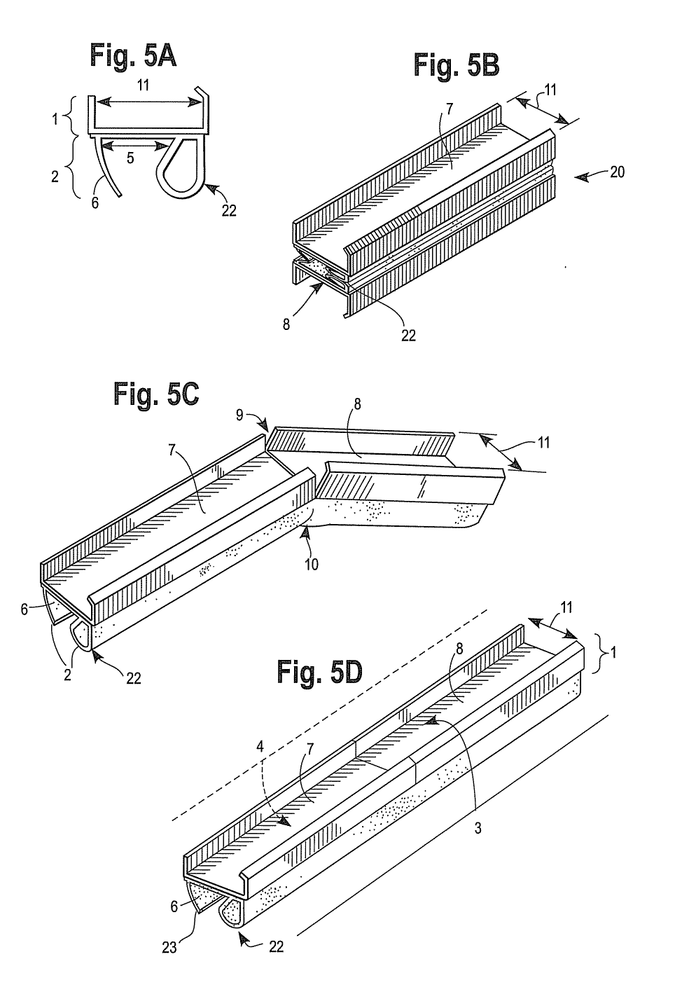

Board 1 may include an optional bottom weather seal 2 (such as shown in FIG. 2A) and/or an optional edge weather seal 6. Bottom weather seal 2, if used, is generally either attached to the board rear surface 3 as separate piece or it can be co-extruded with board 1 as a single structure. An embodiment of bottom weather seal 2 (shown in FIG. 5A) is generally associated with door trim that is attached to the bottom surface of a garage door. Once installed weather seal 2 helps to prevent elements such as rain, snow, heat, cold, dust, insects and refuse from entering a garage when the garage door is closed. For example, FIGS. 5A-5D show a weather seal 2 associated with board 1 and further including a edge seal 22 and a sweep seal 23. Materials suitable for weather seal 2 are generally the same as those suitable for use in manufacturing board 1. However, weather seal 2 does not need to be as stiff as board 1, so the board and weather seal materials may be different with the weather seal material generally being selected from a material that is weather-resistant and durable to prevent ripping or cracking during frigid temperatures but that is malleable enough to bend and move under pressure. In one embodiment, the weather seal will be formed from a plastic material that is more mealable than a plastic material used to form board 1.

Board 1 may also include an optional edge seal 6. Edge seal 6 may be manufactured independently from board 1 and then attached to an edge 11 of board 1. Alternatively, edge seal 6 can may be manufactured as an integral part of board 1 by an extrusion or co-extrusion process. Edge seal 6 will typically be angled slightly inwardly with respect to edge 11 of board 1 so that edge seal 6 is urged against a side or top wall of a garage door opening when the trim 20 is installed.

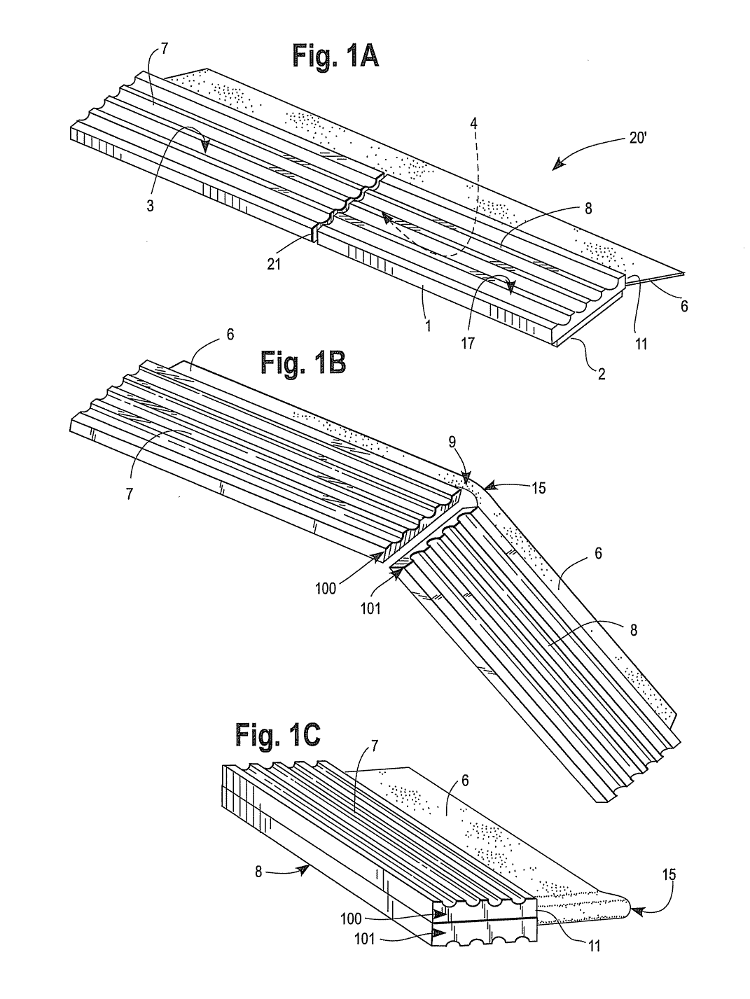

Board 1 includes at least one hinge 10 that separates at least a first board section 7 and a second board section 8. The manner in which hinge 10 is constructed in trim 20 is discussed in more detail below. Hinge 10—depending upon its type—allows first board section 7 to be folded up to 180° with respect to second board section 8. The folding of first board section 7 towards or against second board section 8 at hinge 10 exposes intermediate board ends 100 and 101. The folding of first board section 7 against second board section 8 at hinge 10 also effectively reduces the length of the continuous piece of garage door trim 20 thereby making the folded garage door trim easier to store and transport before installation. During installation folded first board section 7 is unfolded at hinge 10 to abut second board section 8 to form a single continuous planar trim piece 20′ shown in FIG. 1A. When the unfolding is complete, intermediate ends 100 and 101 abut one another, forming a continuous unfolded garage door trim system 20 ready for installation.

For purposes of this invention, the term “hinge” refers to any type of union between two board sections that (1) unites—preferably irreversibly—adjacent first board section 7 and second board section 8; and (2) that allows the adjacent first and second board sections 7 and 8 to be folded at one or more angles from just over 0 to up to 180 degrees with respect to one another. More preferably, the hinge will be an integral hinge that is formed by removing or cutting through at least part of one of the board, the bottom seal or the edge seal such that adjacent board sections are foldable with respect to one another at the same time the first and second board sections remain irreversibly united with one another. Several types of hinges that meet these criteria are discussed below. However, the present invention is not limited to the types of hinges discussed below so long as they meet the hinge criteria set forth above.

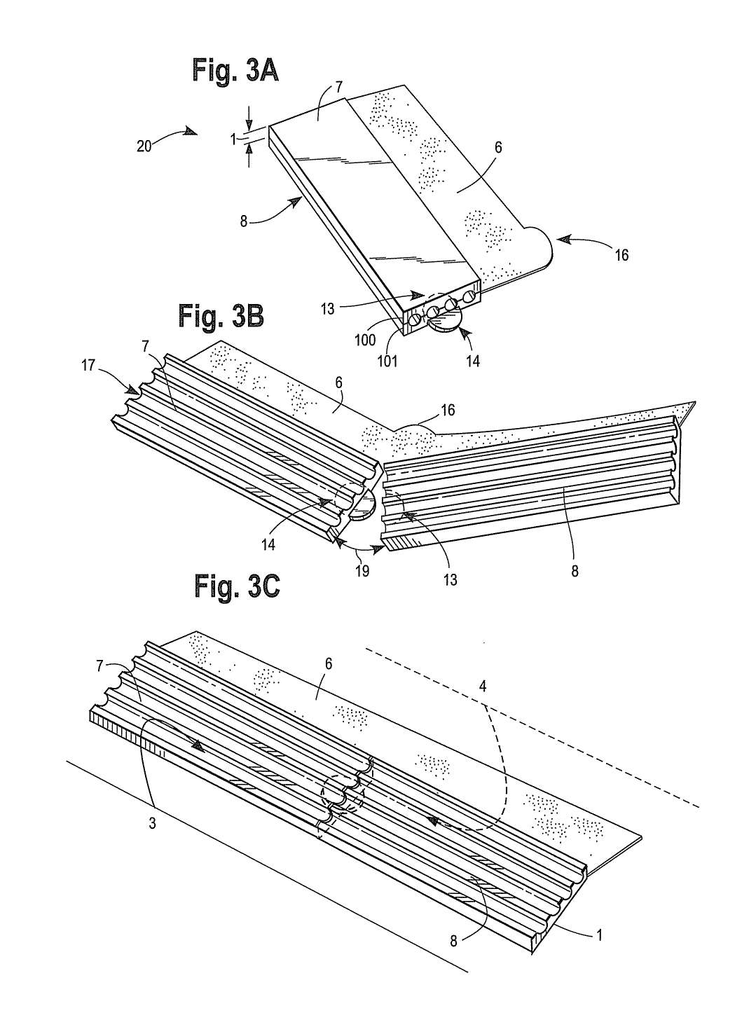

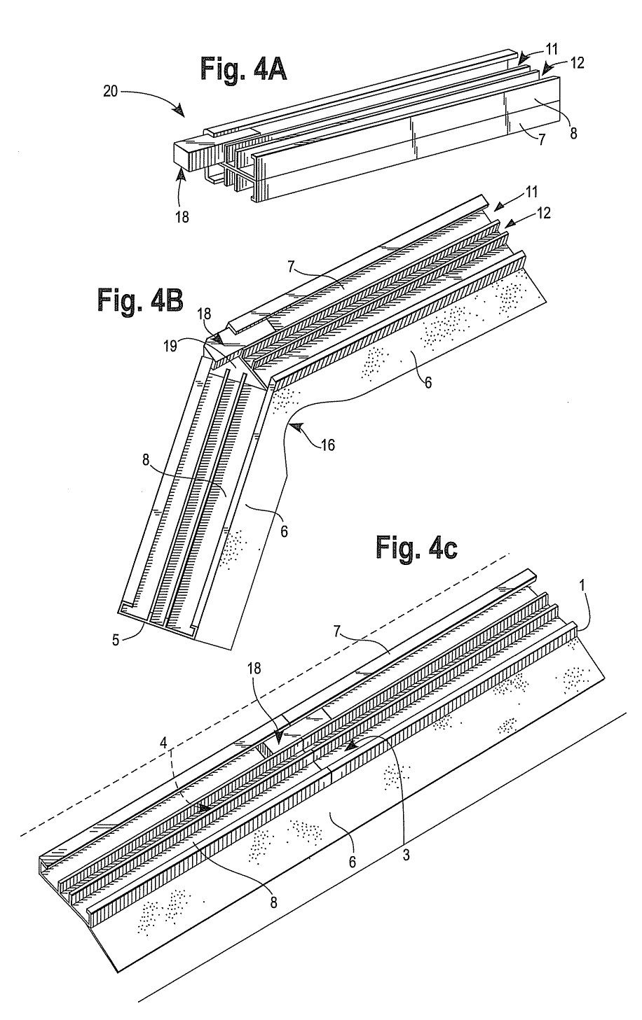

One useful type of hinge 10 is a complete cleave hinge. The term “complete cleave” as used herein refers to a hinge that includes a cut into and across the width of board 1 that forms a gap 21 between a first board section 7 and second board section 8 that extends all of the way through board 1 and optional bottom weather seal 2. A complete cleave hinge must include an edge seal 6 that remains intact, i.e. it is not cut in the area of the cleave. Maintaining the integrity of edge seal 6 creates a hinge as shown in FIG. 3A-3B and 4B that allows adjacent board sections 7 and 8 to be folded with respect to one another using edge seal 6 as the hinge that remains intact when the board sections are folded.

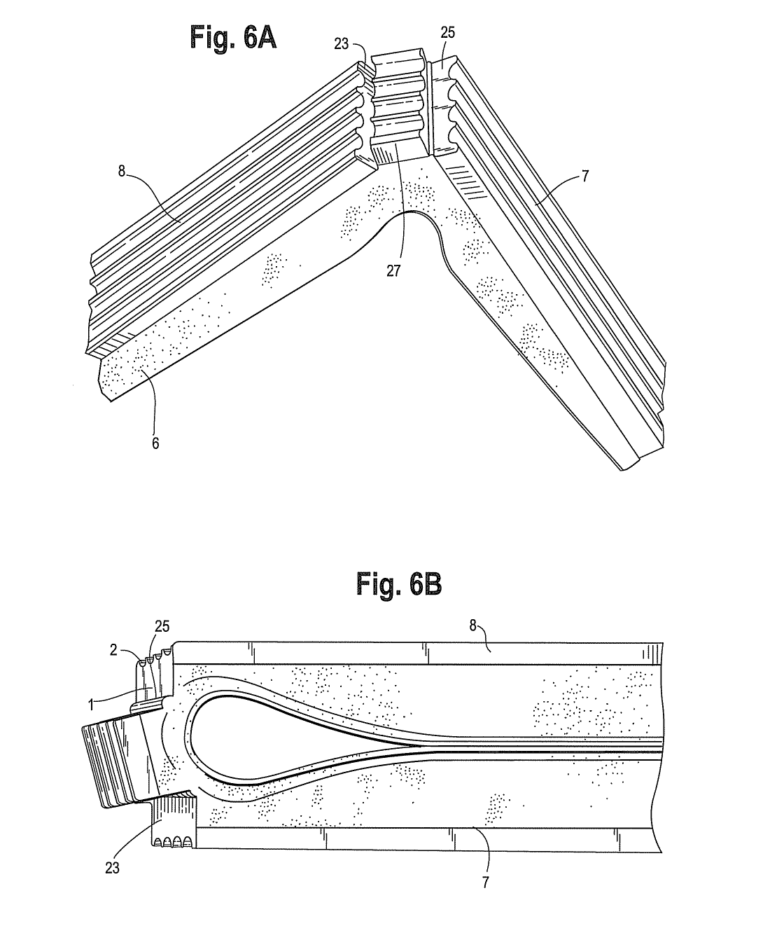

Another useful type of hinge in is a partial cleave hinge shown for example in FIGS. 2G-2H and FIGS. 6A-6B. The term “partial cleave hinge” refers to hinge formed by making a cut into and across the width of board 1 to form an at least partially closed gap 21 between first board section 7 and a second board section 8. Since this gap 21 is at least partially closed, the cut in the partial cleave hinge may not extend all of the way through the entire width of bottom weather seal 2 at the cut—or, in the case where there is no bottom weather seal 2, the cut does not extend completely across the width of board 1. The cut must, however, extend sufficiently through board 1 in the absence of weather seal 2—or sufficiently through weather seal 2—to allow adjacent board sections 7 and 8 to fold with respect to one another without damaging the remaining uncut board section or uncut weather seal section forming that forms the partial cleave hinge. In one embodiment, weather seal 2 can be thin enough such that the cut through board 1 that forms gap 21 will extend completely through board section 1 but it will not enter or extend into weather seal 2. In another embodiment, where weather seal 2 is a thick material, the cut may extend completely through board 1 and into weather seal 2 to a depth sufficient to allow adjacent board sections to fold with respect to one another again without damaging weather seal in the area of the cut.

A further hinge embodiment as shown in FIG. 6A-6B. The seal shown in these figures is a continuous extruded polymer seal having a board portion 1, a weather seal portion 2, and an edge seal 6. The hinge 10, shown in FIG. 6A-6B includes two cuts 23 and 25. The cuts are made to the bottom side of board 1 where they end at weather seal 2. The two cuts 23 and 25 are separated by a short hinge section 27 that separates first board section 7 and second board section 8. The double cut hinge shown in FIGS. 6A and 6B allow first board section 7 and second board section 8 to be bent up to 90° with respect to hinge section 27 thereby allowing the board sections to be orientated 180° with respect to one another.

Many variations and modifications may be made to the hinges above. For example, the cuts made to form the hinge can be made either first into board 1 and end in weather seal 2 or they may be made into weather seal 2 and end in board 1. Alternatively, a portion of the cut can extend completely through board section 1 and weather seal 2 so long as a portion of board 1 or weather seal 2 along the cut remains intact to form a hinge. What is important is that some sort of irreversible connection between first board section 7 and second board section 8 remains that allows the board sections to be folded with respect to one another but that also allow the board sections to be reorientated along the same plane by unfolding without creating a significant gap between board sections when the seal is installed around a garage door. Examples of some partial cleave hinge embodiments are shown in FIGS. 2B-2C, and 2D-2E. A Partial cleave 9 is formed by creating a cut across the width of board 1 to form first board section 7 and second board section 8. Partial cleave 9 does not extend through weather seal 2, thus creating thin uncut section 25 of board 1 and or an uncut section 27 of weather seal 2 that forms a hinge 10 in between the board sections for folding and unfolding. Cutting is accomplished by conventional methods, including sawing, laser cutting and punch pressing.

In some embodiments as shown in FIGS. 2B-2C and 2E-2F, hinge 10 may be created in board 1 by partial contiguous attachment in board 1 between the board sections. Further contiguous attachment is established between the board sections and weather seal 2 and edge seal 6 in which partial cleave 9 may extend to or into the weather seal 2′ along less than the entire width of the weather seal. In other words, the hinge includes interruptions 17 in board 1 between adjacent cuts that extend to weather seal 2′ as shown for example in FIGS. 2B and 2C.

In another embodiment, as shown in FIGS. 1B, 2D, 2G, 2H and 5C, hinge 15 may be formed in weather seal 2 and edge seal 6 by non-contiguous attachment of the board sections to weather seal 2, which may also extend into weather seal 2 by partial cleave 9 at a depth less than the whole of the width of weather seal 2. In some embodiments, partial cleave 9 can be pre-cut into board 1 before attachment weather seal 2 and can be oriented from either rear surface 3 or front surface 4 of board 1. In other embodiments, partial cleave 9 can be cut along the x-axis to establish hinge 15.

Board 1 will typically have a length ranging from about 8 feet to about 20 feet or more and a width of from about 1 to about 12 inches or more. The first board section 7 and second board section 8 of board 1 will have a length that is generally short enough to allow the board sections to be boxed, stored, mailed and/or transported without undue difficulty. Board sections 7 and 8 will have lengths from about 4 feet to about 10 feet or more. It is possible for board 1 to have a plurality of hinges where each hinge is located between adjacent board sections. That way, a very long board 1 can be folded at two or more hinges to reduce its length to a length that is acceptable for shipping, storing and for displaying in a box such as a box located at a hardware store.

Board 1 is attached to the perimeter door frame or bottom of the garage door in a manner that causes surface 3 to abut the garage door bottom as shown in FIG. 5D or to abut the side or top perimeter of the garage door opening as shown in FIGS. 1A and 4C. Moreover, board 1 may have fittings 11, slots 12, or grooves 17 that facilitate the attachment of board 1 to the bottom of the garage door or to the garage door frame.

The foldable door trim of this invention may include a plurality of board sections wherein abutting board sections are separated by hinges that allow adjacent board sections 7 to be folded with respect to one another for storage and transport. Board 1, weather seal 2 and edge seal 6 may be made of any materials that are suitable and/or known to be used in manufacturing garage door trim. Generally, malleable polymers and plastics are preferred because of their resistance to weather, chemical, and to damage. Examples of some materials that are suitable for manufacturing board 1 include, but are not limited to, durable wood, rubber, vinyl, plastic and cellular PVC.

The door seals of this invention may include optional inserts as shown 14 in FIGS. 3A-3C or 18 as shown in FIGS. 4A-4C. Inserts 14 and 18 are useful for strengthening the union between a first board section 7 and a second board section 8 when the sections are unfolded and united. Inserts 14 and 18 can be any device or material that is useful for uniting two corresponding pieces of material such as dowels or biscuits that are press-fit or glued into place in complementary apertures 13 in intermediate ends 100 and 101 of adjacent board sections 7 and 8. Materials suitable for the optional inserts include durable wood, rubber, vinyl, plastic and cellular PVC.

In another embodiment shown in FIG. 2A, edge seal 6 includes a second layer of material 31 that is different from the edge seal material 6. The second layer of material 31 is typically co-extruded with the edge seal 6. The second layer of material 31 is useful where the edge seal material could crack or break under cold conditions and/or when bent to form a hinge. The second layer of material 31 is generally a material that is softer and more malleable than material used form edge seal 6.

Installation of the garage door trim is accomplished by unfolding at least the first board section 7 from the second board section 8 to form a planar door seal 20 and then placing door seal 20 against the lentil or jambs of a door frame or against the bottom of a bottom most garage door panel. The seal is attached to the bottom of a door or frame by any conventional method, including but not limited to gluing, nailing, stapling or screwing. The seal is similarly attached to door frame. The seal may include any types of features that are useful in attaching the seal to a garage door lentil or perimeter. For example, the seal can include recessed apertures through which nails or bolts can be placed such that when the bolts are nails are associated with the garage door perimeter, the bolt heads and nail heads do not lie above the seal material.

As noted above, the seals of this invention can be manufactured as a single extruded piece of material or they can be manufactured by adhering several pieces to one another. For examples, the board section and optional weather seal and edge seal sections can be separately manufactured and combined using adhesives or other attaching means or they can be co-extruded.

In other embodiments of the invention, the weather seal can be laminated to the front surface of the board. This yields the advantage of the weather resistant properties of the weather seal and the economic factor of using a less flexible or pliable material as the board.

It will be apparent to those skilled in the art that various modifications and variations can be made to the present invention without departing from the scope of the invention. Thus, it is intended that the present invention cover the modifications and variations of this invention provided they come within the scope of the appended claims and their equivalents.

What is claimed is:

1. A door trim comprising a board having a front surface, a rear surface and an optional edge seal wherein the board includes at least one hinge separating a first board section from an adjacent second board section.

2. The door trim of claim 1 wherein the hinge includes a gap in the board between the first board section and the second board section wherein the gap extends along the entire width of the board and wherein the gap does not extend all of the way through the board section.

3. The door trim of claim 1 wherein the board includes a bottom weather seal and wherein the hinge is a partial cleave hinge.

4. The door trim of claim 3 wherein the partial cleave passes through the board.

5. The door trim of claim 4 wherein the partial cleave extends partially into the bottom weather seal.

6. The door trim of claim 3 wherein the partial cleave passes through the board and into the board bottom seal.

7. The door trim of claim 3 wherein the partial cleave extends at least partially into the board bottom weather seal but does not extend into the board.

8. The door trim of claim 3 wherein the partial cleave extends through the bottom weather seal and into the board.

9. The door trim of claim 3 wherein the door trim includes an edge weather seal and the partial cleave passes through the edge weather seal.

10. The door trim of claim 1 wherein the hinge allows the first board section to be folded at an angle of up to 180 degrees with respect to the adjacent second board section.

11. The door trim of claim 1 wherein the board includes a plurality of board sections and wherein adjacent board sections are separated by a hinge.

12. The door trim of claim 11 wherein the board has a length of from about 8 to about 20 feet and a width of from about 1 to about 12 inches and wherein each board section has a length of from about 4 to about 10 feet.

13. The door trim system of claim 1 wherein the trim includes an edge seal and wherein the hinge is a complete cleave hinge.

14. The door trim system of claim 1 wherein the end weather includes a first layer of material and a second layer of material wherein the second material layer is selected from a material that is softer than the first material layer.

15. The door trim of claim 2 wherein each board section includes a at least one slot and wherein at least one insert is located into slots in adjacent board sections when the board sections are unfolded with respect to one another.

16. The door trim of claim 1 wherein the hinge comprises to adjacent cuts.
